(19) United States
(12) Patent Application Publication
(10) Pub. No.: US 2012/0284119 A1
(43) Pub. Date: Nov. 8, 2012

(54) SYSTEM AND METHOD FOR SELECTING WEB PAGES ON WHICH TO PLACE DISPLAY ADVERTISEMENTS

(75) Inventors: Jian Hu, Beijing (CN); Hao Zheng, Beijing (CN)

(73) Assignee: YAHOO! INC., Sunnyvale, CA (US)

(21) Appl. No.: 13/499,531

(22) PCT Filed: Dec. 23, 2010
(86) PCT No.: PCT/CN2010/002143

§ 371 Date: Mar. 30, 2012

(51) Int. Cl. G06Q 30/02

(52) U.S. Cl. 705/14.52

(57) ABSTRACT

A system and method is described herein that assists a user with selecting a Web page on which to place a display advertisement. The user, such as an advertiser, is provided with user interface elements that allow the user to selectively obtain statistical information on Web page categories as well as on Web pages in selected Web page categories. The user can also select perform key word searches to search for content of Web pages in the selected Web page categories. As a result, the user is provided with user interface elements that give him or her control over selection of Web pages where the display ads are placed.

### BACKGROUND OF THE INVENTION

### Field of the Invention

The present invention generally relates to systems and methods for assisting a user in selecting Web pages on which to place display advertisements.

### Background

Online advertising refers to the delivery of advertising content to users via a network, such as the Internet. Such advertising content may be inserted within Web pages, e-mails, or other documents delivered to the users via the network. Online advertising provides a number of advantages as compared to other conventional forms of advertising. These advantages include, among others, the ability to quickly reach a massive and growing global audience of users, the ability to perform highly-targeted and personalized marketing, and the ability to immediately capitalize on user interest by providing a direct link to an advertiser's Web site. Due to advantages such as these, the market for the placement of online advertisements (“ads”) has grown rapidly as more and more companies are setting aside marketing budget for online advertising.

In recent years, sophisticated ad delivery systems have been developed that operate to dynamically insert online ads, such as display ads, into network-accessed documents at the time such documents are served to or browsed by users. In accordance with many ad delivery system models, an advertiser or other entity develops a display ad and then provides it to an ad serving system for insertion into Web pages published by one or more publishers. The destination Web pages may include, for example, Web pages published by or associated with companies that aggregate content such as YAHOO! Inc. of Sunnyvale Calif., online shopping Web pages, online auction Web pages, social networking Web pages, or the like.

A publisher of multiple Web pages may assist in helping advertisers select which of the multiple Web pages should be targeted for the placement of display ads. For example, such advertisers may provide the publisher with targeting criteria as well as a list of potential display advertisements. The publisher typically uses the targeting criteria to select Web page(s) on which to place the display ads provided by the advertisers. However, except for providing the targeting criteria, the advertisers typically don't have much, if any, control over which Web pages are selected for display ad placement. Instead, the publisher typically selects the Web page targets manually and/or using proprietary tools that are not available to the advertisers.

It would be advantageous if the advertisers had more control over selecting Web page(s) on which to place display advertisement(s).

### BRIEF SUMMARY OF THE INVENTION

A system and method in accordance with an embodiment of the present invention assists a user in selecting a Web page on which to place a display advertisement. The user, such as an advertiser, is provided with user interface elements that allow the user to selectively obtain statistical information on Web page categories as well as on Web pages in selected Web page categories. The user can also perform key word searches to search for content of Web pages in the selected Web page categories. As a result, the user is provided with user interface elements that give him or her control over selection of Web pages where the display ads are placed. The user-interface elements can be a part of a self-service system that allows the user to select these Web pages. The self-service system may also allow the user to select the display ads and their placement on the selected Web pages.

In particular, a method for assisting a user in selecting a Web page on which to place a display advertisement is described herein. In accordance with the method, a first user interface element is provided that allows a user to selectively obtain statistical information relating to each Web page category. The first user interface also allows the user to select one or more Web page categories based on the statistical information. A second user interface element is provided that allows the user to submit one or more key words. A third user interface element is provided that displays a list of Web pages obtained from the selected Web page categories by performing a search based on the key word(s). The third user interface element also allows the user to selectively obtain statistical information relating to each Web page in the list of Web pages. The third user interface element also allows the user to select Web page(s) in the list of Web pages as a target for the placement of a display advertisement.

A system is also described herein. The system includes a display module, an input module, and an index search module. The display module is configured to display first statistical information relating to each of one or more Web page categories. The input module is configured to receive a user selection of a Web page category from the Web page categories. The selected Web page category includes a plurality of Web pages. The input module is also configured to receive one or more key words. The index search module is configured to search an index that indexes content of the Web pages included in the selected Web page category for the key word(s) to create a list of Web pages selected from the Web pages. The display module is further configured to display second statistical information relating to each Web page in the list of Web pages.

A computer program product that comprises a computer-readable medium having computer program logic recorded thereon for enabling a processor to assist a user in selecting a Web page on which to place a display advertisement is also described herein. The computer program logic comprises first and second means. The first means is for enabling the processor to provide a first user interface element that allows a user to selectively obtain statistical information relating to each Web page category. The first means is also for enabling the processor to select one or more of the Web page categories based on the statistical information. The second means is for enabling the processor to provide a second user interface element that allows the user to select a filter that is to be applied to the selected Web page category to select one or more Web pages as a target for placement of a display advertisement.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of an example online advertisement (“ad”) network in which an embodiment of the present invention may operate.

FIG. 2 depicts a flowchart of a method for assisting a user in selecting Web pages on which to place display advertisements in accordance with an embodiment described herein.

FIG. 3 depicts a diagram of an exemplary graphical user interface (GUI) including multiple user interface elements in accordance with an embodiment described herein.

FIG. 4 depicts a diagram of an exemplary GUI including another user interface element in accordance with an embodiment described herein.

FIG. 5 is block diagram of a Web page selection assistant that may implement the method of FIG. 2 in accordance with an embodiment described herein.

FIG. 6 is a block diagram of an example computer system that may be used to implement embodiments described herein.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

### B. Example Operating Environment

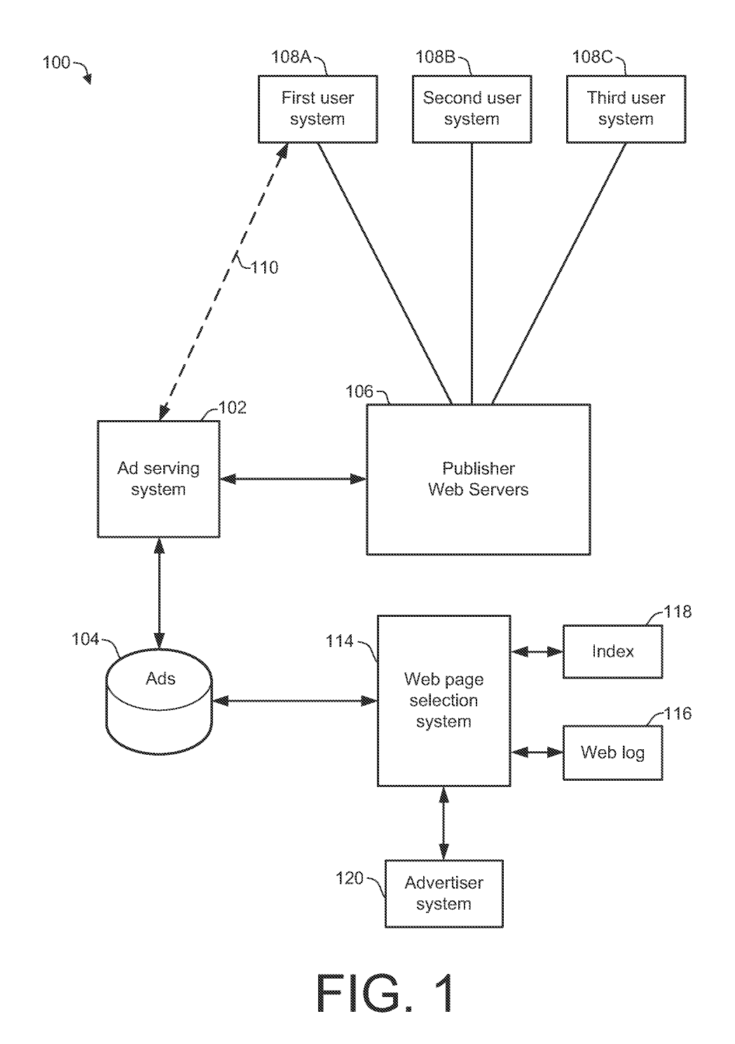

FIG. 1 is a block diagram of an example online advertisement (“ad”) network 100 in which an embodiment of the present invention may operate. Generally speaking, online ad network 100 operates to serve online ads, such as display ads, on Web pages published by publishers when such Web pages are accessed by certain users of the network, thereby delivering the display ads to the users. As shown in FIG. 1, online ad network 100 includes an ad serving system 102, an ads database 104, a plurality of publisher Web servers 106, a plurality of user systems 108A-108C, a Web page selection system 114, and an advertiser system 120. Publisher Web servers 106 are configured to host Web pages published by a publisher (e.g., YAHOO!) so that such Web pages are accessible to users of network 100. A user may access such Web pages using a Web browser or other Web client installed on a system owned by or otherwise accessible to the user. By way of example, FIG. 1 depicts a plurality of user systems 108A-108C, each of which executes a Web browser that enables a user to visit any of the Web pages hosted by publisher Web servers 106. As depicted in FIG. 1, each of user systems 108A-108C is communicatively connected to publisher Web servers 106 for the purpose of accessing a Web page published by the publisher.

In one embodiment, each of user systems 108A-108C comprises a desktop computer. However, persons skilled in the relevant art(s) will appreciate that user systems 108A-108C may include any Web browser-enabled system or device, including but not limited to laptop computers, personal digital assistants, cellular telephones, or the like. In one implementation, communication between user systems 108A-108C and publisher Web servers 106 is carried out over a wide area network, such as the Internet, using well-known network communication protocols.

As further shown in FIG. 1, ad serving system 102 is communicatively connected to publisher Web servers 106. Communication between ad serving system 102 and publisher Web servers 106 may also be carried out over a wide area network such as the Internet or other suitable communication channel. In one implementation, ad serving system 102 is configured to deliver online ads to publisher Web servers 106 when certain Web pages hosted by publisher Web servers 106 are accessed by certain users, thereby facilitating the delivery of such online ads to the users. In such an implementation, publisher Web servers 106 are configured to serve the ads along with Web page content to the users.

For example, a display ad may be provided by ad serving system 102 to one of publisher Web servers 106 to be placed on a Web page. One of publisher Web servers 106 may incorporate, such as by embedding, the display ad received from ad serving system 102 into the Web page. Once the display ad is embedded in the Web page, the Web page may be delivered by one of publisher Web servers 106 to the user system (e.g., any of user systems108A-108C) for display by the user system's Web browser.

In an alternative implementation, publisher Web servers 106 are configured to embed a request to ad serving system 102 along with Web page content served to certain users. In response to the execution of the embedded request by a Web browser running on a user system, ad serving system 102 will deliver an online ad to the user system for display within the context of the Web page content. In this alternate implementation, a direct connection is established between a user system and ad serving system 102. An example of such a direction connection between first user system 108A and ad serving system 102 is shown in FIG. 1 as connection 110. This direct connection may also be established over a wide area network such as the Internet.

The display ads to be delivered to the users may be provided by one or more advertisers and may be stored in an ads database 104. Ads database 104 may be stored in a memory system or device that is accessible to ad serving system 102. Although only a single ads database 104 is shown in FIG. 1, persons skilled in the relevant art(s) will appreciate that the display ads may be stored in multiple ads databases. Each display ad provided by an advertiser may be associated with a particular ad campaign sponsored by the advertiser.

Online ad network 100 also includes a Web page selection system 114 that is configured to assist a user in selecting Web page(s) on which to place display ads. Although the user of Web page selection system will be described herein as an “advertiser,” it is to be understood that the system is not so limited, and may be used by persons acting on behalf of advertisers, or other persons entirely. Web page selection system 114 provides a user interface that allows the advertiser to select Web pages upon which to place display ads. In one embodiment, the user interface is a Web interface, and elements of the user interface are delivered from Web page selection system 114 to advertiser system 120, which may comprise, for example, a desktop computer executing a Web browser. In an alternate embodiment, a client-server model is not used, and the advertiser directly accesses Web page selection system 114 without using advertiser system 120.

As noted above, in one embodiment, advertiser system 120 comprises a desktop computer. However, persons skilled in the relevant art(s) will appreciate that advertiser system 120 may include any Web browser-enabled system or device, including but not limited to laptop computers, personal digital assistants, cellular telephones, or the like. In one implementation, communication between advertiser system 120 and Web page selection system 114 is carried out over a wide area network, such as the Internet, using well-known network communication protocols.

As noted above, Web page selection system 114 can assist an advertiser in selecting a Web page on which to place display advertisement(s) by providing various user interface elements to advertiser system 120. Web page selection system 114 can provide the user interface elements to advertiser system 120 in various ways, such as by providing interactive Web pages that can be displayed by a Web browser executing on advertiser system 120. The advertiser may interact with the user interface elements displayed by the Web browser to analyze and select Web pages. The Web browser on advertiser system 120 may communicate data that includes certain user input from the user interface elements to Web page selection system 114.

As will be discussed in more detail herein, the user interface elements enable the advertiser to selectively obtain statistical information relating to each of a plurality of Web page categories and to select one or more of the Web page categories based on the statistical information. The user interface elements also enable the advertiser to perform a key word search or to apply other filters to identify Web pages of interest within a selected Web page category and to selectively obtain statistical information relating to each Web page of interest. Furthermore, the user interface elements enable the advertiser to select one or more Web pages from among the Web pages of interest as a target for the placement of a display advertisement. The user-interface elements can be a part of a self-service system that allows the advertiser to select these Web pages. The self-service system may also allow the advertiser to select display advertisements and their placement on the selected Web pages.

Once the advertiser selects the Web page(s) for display ad placement, Web page selection system 114 may store this selection such that it can be used by ad serving system 102 to determine where to place display ads provided by the advertiser. In one embodiment, this selection may be stored along with the advertiser's display ads in ads database 104. However, the scope of the example embodiments is not limited in this respect.

By providing the user interface elements, Web page selection system 114 provides the advertiser with analysis tools that can be used to find and analyze Web pages of interest prior to selecting them for display ad placement. By assisting an advertiser in selecting a Web page on which to place a display advertisement, Web page selection system 114 can advantageously improve the ad targeting capability of advertisers.

Web page selection system 114 gives the advertisers control by allowing them to select, with certainty, Web pages where the display ads are placed. This approach also represents an improvement over one in which the advertiser merely provides a publisher with targeting criteria and display ads, and the publisher determines the Web pages upon which the display ads are to be placed based on the targeting criteria. This conventional approach does not provide the advertiser with control over selection of Web pages where the ads are placed. In other words, when using the conventional approach, the advertiser is not certain whether a particular Web page will actually be selected for display ad placement.

Therefore, Web page selection system 114 allows advertisers to accurately select Web pages for targeting potential customers. Web page selection system 114 allows advertisers to reduce the total number of Web pages that are used for display ad placement, therefore minimizing advertising cost. At the same time Web page selection system 114 offers advertisers a chance to maximize their return on investment (ROI) by allowing them to select the Web pages where the display ads will be most effective.

Particular examples of how Web page selection system 114 may assist a user in selecting a Web page on which to place a display advertisement will be described in more detail below. In one embodiment, Web page selection system 114 comprises one or more computers, such as one or more servers. Web page selection system 114 may be implemented in hardware, software, firmware, or any combination thereof For example, Web page selection system 114 may include software/firmware that executes in one or more processors of one or more computer systems, such as one or more servers.

### C. Assisting a User in Selecting a Web page on Which to Place a Display Advertisement

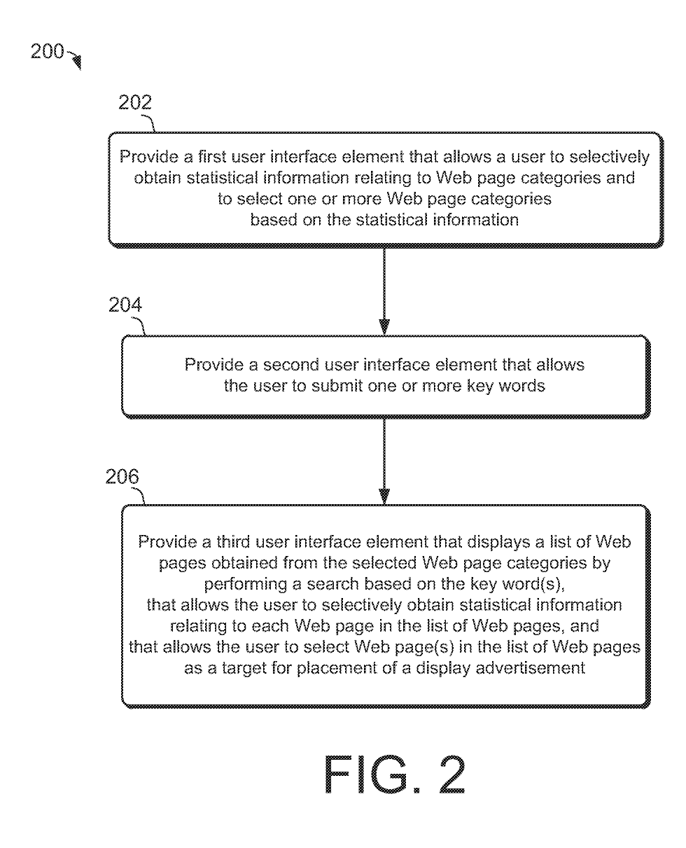

FIG. 2 depicts a flowchart 200 of a method for assisting a user in selecting a

Web page on which to place a display advertisement in accordance with an embodiment described herein. The method of flowchart 200 will be described in reference to elements of system 100. However, it is noted that the method is not limited to that implementation. Also, the method of flowchart 200 may be modified by those skilled in the art in order to derive alternative embodiment(s). Furthermore, the steps of flowchart 200 may occur in a different order than shown, some steps may be performed concurrently, some steps may be combined with other steps, and/or some steps may be absent, as desired.

As shown in FIG. 2, the method of flowchart 200 begins at step 202 in which a first user interface element is provided that allows a user to selectively obtain statistical information relating to Web page categories. The first user interface element also allows the user (e.g., the advertiser) to select one or more Web page categories based on the statistical information.

In one implementation, the first user interface element may be provided by Web page selection system 114 to a Web browser that executes on advertiser system 120. A user, such as the advertiser, may use the first user interface element by accessing the Web browser on advertiser system 120.

The first user interface element allows the advertiser to selectively obtain statistical information relating to Web page categories. The Web page categories may represent topically-related groupings of the Web pages that are published by publisher Web servers 106. Such Web page categories may be arranged using a hierarchical taxonomy. For example, the Web page categories may be classified using a hierarchically-organized taxonomy based on topics of Web pages included in each category. The hierarchical taxonomy may have multiple levels. The provided first user interface element may allow the advertiser to selectively obtain statistical information relating to each of the plurality of Web page categories from any level(s) in the hierarchical taxonomy. However, the scope of the example embodiments is not limited in this respect, and the Web page categories may be arranged using other techniques.

The statistical information relating to Web page categories may include, for each Web page category that a user selects for analysis, demographic information and geographical distribution information associated with all the users that access Web pages in that Web page category, as well as page impression information for all the Web pages in that Web page category, as well as other statistical information.

Demographic information includes information characterizing the types of users that access the Web pages in the Web page category. The demographic information may be determined by analyzing a Web log, such as Web log 116 of FIG. 1. The demographic information may include, for example and without limitation, data such as average age and gender of the users that access Web pages in the Web page category. The demographic information may also include certain socio-economic characteristics of users that may be useful to the advertiser. The demographic information may be analyzed, e.g., by using historical data to provide advanced information such as demographic trends over time, etc.

Geographical distribution information includes information characterizing the users that access the Web pages in the Web page category, such as the geographical location of those user(s). The geographical distribution location may also be determined by analyzing a Web log, such as Web log 116. Advanced geographical information may include information such as whether the geographical distribution of users fluctuates over time, etc.

Page impression information includes information characterizing the Web pages in the Web page category, such as access patterns for these Web pages. The page impression information may also be determined by analyzing a Web log, such as web log 116. The page impression information may include a number of user visits to all the Web pages in the Web page category over a certain time period, a number of times certain ad(s) in the Web page were accessed (e.g., clicked-on), as well as advanced information such as user access patters over time, etc.

The first user interface element allows the advertiser to select the one or more Web page categories based on the statistical information, i.e., after obtaining the statistical information for various Web page categories. However, it is understood that the first user interface element also allows the advertiser to select the one or more Web page categories without the advertiser obtaining statistical information for any Web page categories.

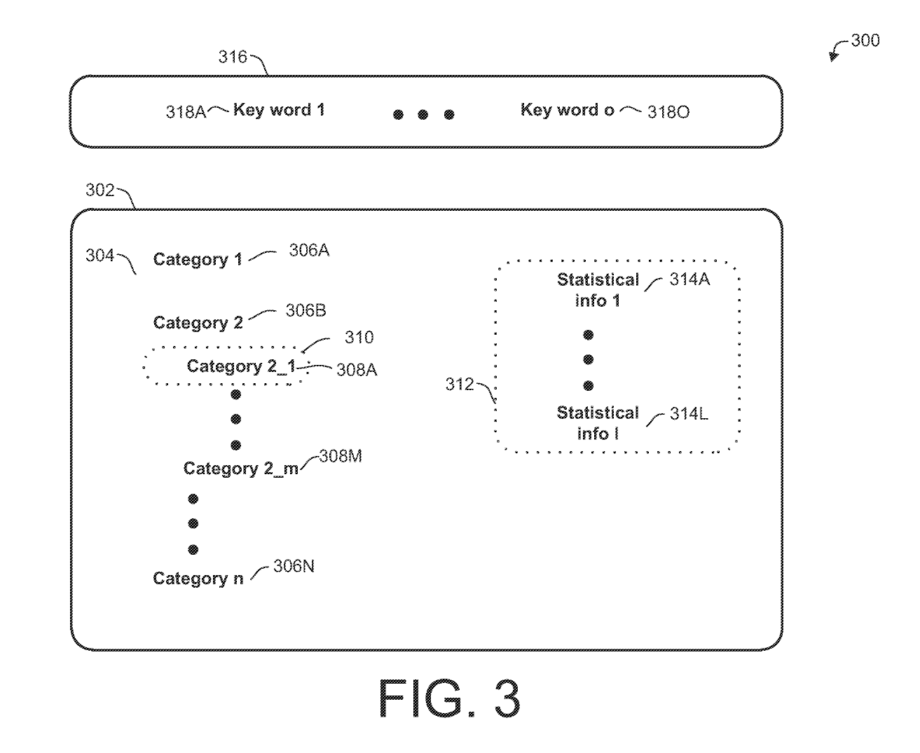

FIG. 3 depicts an exemplary graphical user interface (GUI) that includes an example of the first user element provided in step 202. In particular, FIG. 3 depicts a GUI 300 that includes multiple user interface elements in accordance with an embodiment described herein. In one embodiment, GUI 300 may be a GUI of a Web browser that executes on advertiser system 120. In accordance with this embodiment, the user interface elements may be provided by Web page selection system 114 to advertiser system 120 in the manner described herein. In one embodiment, GUI 300 may be a GUI of a self-service system (e.g., provided by a Web browser that executes on advertiser system 120) that allows the advertiser to select the Web pages where the display ads are placed. The self-service system may also allow the advertiser to select the display ads and their placement on the selected Web pages.

As shown in FIG. 3, GUI 300 includes a first user interface element 302, such as can be provided in step 202 of flowchart 200. First user interface element 302 displays a plurality of Web page categories 304. Web page categories 304 may be arranged using a hierarchical taxonomy, as described above. For example, as shown in FIG. 3, Web page categories 304 include a first level of Web page categories 306A, . . . , 306N and a second level of Web page categories 308A, . . . , 308M, though the scope of the example embodiments is not limited in this respect. As shown in FIG. 3, second Web page category 306B (in first level of Web page categories 306A, . . . , 306N) may be expanded such that second level of Web page categories 308A, . . . , 308M is also displayed, where second level of Web page categories 308A, . . . , 308M may be a sublevel of second Web page category 306B.

First user interface element 302 allows the advertiser to selectively obtain statistical information relating to each of Web page categories 304. First user interface element 302 displays statistical information 312 relating to any Web page category that the advertiser selects. For example, statistical information 312 may relate to second Web page category 306B that the advertiser has selected. Statistical information 312 may include multiple statistical information elements 314A, . . . , 314L. For example, statistical information element 314A may display geographical information relating to advertiser-selected second Web category 306B, and other statistical information elements may display different statistical information for that Web category 306B. Although FIG. 3 shows that statistical information 312 is displayed in a same window as Web page categories 304, the scope of the example embodiments is not limited in this respect. For example, statistical information 312 may be displayed in a separate window and/or on a different screen from Web page categories 304.

FIG. 3 also shows that first user interface element 302 allows the advertiser to select one or more Web page categories, such as by using a selection box 310, though the scope of the example embodiments is not limited in this respect. First user interface element 302 allows the advertiser to select Web page categories in various ways, including but not limited to a mouse click on a Web page category, an advertiser-entered text referencing the Web page category to be selected, etc.

Returning now to the description of FIG. 2, in step 204, a second user interface element is provided that allows the advertiser to submit one or more keywords. Like step 202, this step may also be performed by Web page selection system 114. The keyword(s) are used in the next step (i.e., step 206) to perform a search. By way of illustration, exemplary GUI 300 of FIG. 3 includes a second user interface element 316 that may be provided in accordance with step 204. Second user interface element 316 allows the advertiser to submit one or more keywords 318A, . . . , 318O.

In step 206, a third user interface element is provided that displays a list of

Web pages obtained from the selected Web page categories by performing a search based on the key word(s). Like steps 202 and 204, this step may also be performed by Web page selection system 114. The search referred to in step 206 may be performed by searching an index, such as index 118, that indexes content of each Web page included in each of the selected one or more Web page categories, for the key word(s). In one embodiment, the index indexes the content of all the Web pages in all the Web page categories and the search is filtered by the selected Web page category. In an alternate embodiment, a separate index is maintained for each Web page category that indexes only the content of the Web pages of that category, and only the index associated with the selected Web page category is searched.

The third user interface element also allows the advertiser to selectively obtain statistical information relating to each Web page in the list of Web pages returned by the key word search. In one embodiment, the statistical information relating to each Web page may be similar to the statistical information relating to each Web page category described above with reference to step 202, but at a more granular level (i.e., at the level of a specific Web page).

The statistical information relating to each Web page may include, for each Web page that the advertiser selects for analysis, demographic information and geographical distribution information associated with users that access the selected Web page, page impression information for the selected Web page, as well as other statistical information associated with the selected Web page.

The third user interface element also allows the advertiser to select one or more Web pages from the list as a target for the placement of a display advertisement. The advertiser may select such Web page(s) from the list based on statistical information obtained for selected Web page(s) in the list. However, it is understood that the third user interface element also allows the advertiser to select Web page(s) as targets for display ads without necessarily obtaining statistical information for such Web page(s), and/or even without performing the key word search. For example, in one embodiment, the third user interface element allows the advertiser to selectively obtain statistical information relating to each Web page in the selected Web page category, such as if advertiser user decided not to perform the key word search on the selected Web page category.

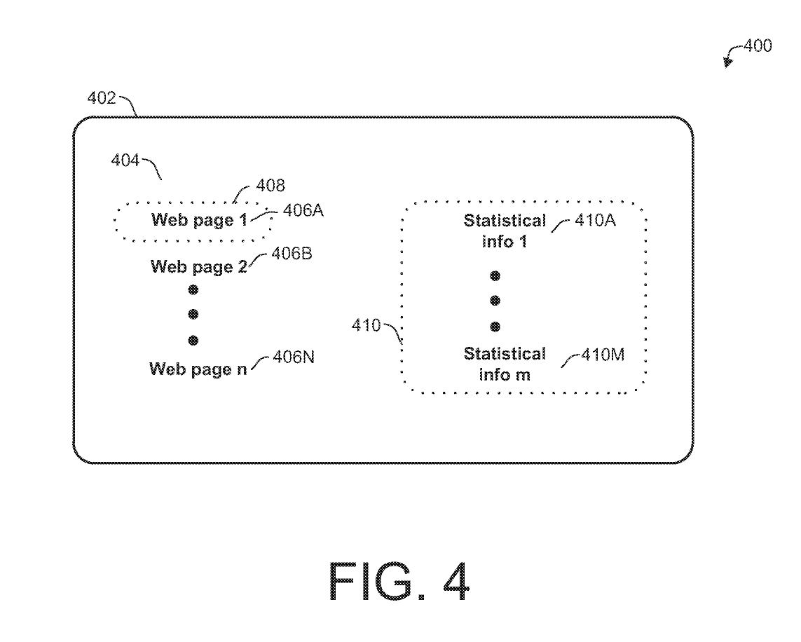

FIG. 4 depicts an exemplary graphical user interface (GUI) 400 that includes an example of the third user element provided in step 206. GUI 400 shown in FIG. 4 may be provided in a similar manner to GUI 300 as described above with reference to FIG. 3.

Third user interface element 402 displays a list of Web pages 404 that includes Web page 1 406A, . . . , Web page n 406N. Third user interface element 402 allows the advertiser to selectively obtain and display statistical information 410 relating to each of these Web pages. Statistical information 410 may include multiple statistical information elements 410A, . . . , 410M. For example, statistical information 410 may relate to Web page 406B that the advertiser has selected and may display geographical information for the advertiser-selected Web page. Other statistical information elements may display different statistical information for that Web page. Furthermore, third user interface element 402 allows the advertiser to select Web page(s) from list of Web pages 404 as a target for the placement of the display ad. For example, as shown in FIG. 4, third user interface element 402 allows the advertiser to select Web pages using a selection box 408, though the scope of the example embodiments is not limited in this respect. Third user interface element 402 allows the advertiser to select Web pages in various ways, including but not limited to a mouse click on a Web page, a user-entered text referencing the Web page to be selected, etc.

In one embodiment, the user interface elements may enable the advertiser to apply one or more filters to identify Web pages of interest within a selected Web page category, such as obtained above with reference to step 202. The advertiser may apply the filter(s) in any order to find and analyze, e.g., by selectively obtaining statistical information, Web pages of interest from the selected Web page category. The filters include a key word search filter as well as other filters, including but not limited to a demographic filter, a page impression filter, and a geographic filter. The user interface elements also enable the advertiser to select one or more Web pages from among the Web pages of interest as a target for the placement of the display ad.

The key word search filter may search an index (such as index 118) that indexes content of Web pages in the selected Web page category for one or more keywords. The key word search filter may operate in a similar manner to the key word search described above with reference to step 206. The key word filter may allow the advertiser to analyze content information for the Web pages of interest.

The demographic filter may select certain Web pages within the selected Web page category based on certain demographic criteria input or selected by the advertiser. The demographic filter may allow the advertiser to analyze demographic information for the Web pages of interest.

The geographic filter may select certain Web pages within the selected Web page category based on certain geographic criteria input or selected by the advertiser. The geographic filter may allow the advertiser to analyze geographic information for the Web pages of interest.

The page impression filter may select certain Web pages within the selected Web page category based on certain page impression criteria input or selected by the advertiser. The page impression filter may allow the advertiser to analyze page impression information for the Web pages of interest.

### D. Web Page Selection Assistant

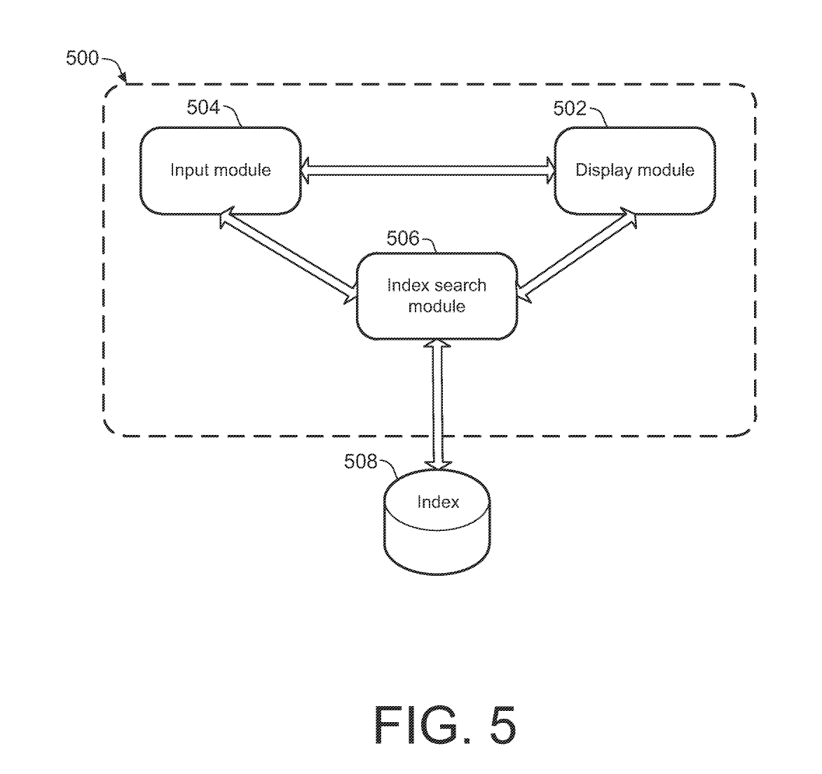

FIG. 5 is block diagram of a Web page selection assistant 500 that may implement method 200 of FIG. 2 in accordance with an embodiment described herein. As shown in FIG. 5, Web page selection assistant 500 includes a display module 502, an input module 504, and an index search module 506 that is communicatively coupled to an index 508. In one embodiment, modules 502, 504 and 506 of Web page selection assistant 500 may be implemented by Web page selection system 114. In another embodiment, one or more of modules 502, 504 and 506 of Web page selection assistant 500 may be implemented and/or located remotely from Web page selection system 114. For example, in one implementation, index search module 506 may be implemented by Web page selection system 114, and display module 502 and/or input module 504 may be implemented by advertiser system 120. For example, a Web browser executing on advertiser system 120 may implement display module 502 and/or input module 504. In another example, an assistant application executing on advertiser system 120 may implement display module 502 and/or input module 504. However, certain statistical information may be provided to display module 502 from Web page selection system 114, such as when display module 502 is implemented on advertiser system 120.

Display module 502 is configured to display first statistical information relating to each of one or more of a plurality of Web page categories. Furthermore, display module 502 is also configured to display second statistical information relating to each Web page in the list of Web pages. For example, display module 502 may display statistical information 312 relating to each of one or more Web page categories. Also, display module 502 may display statistical information 410 relating to each Web page in a list of Web pages. In one embodiment, display module 502 may display Web page categories 304 and keyword(s) 318A, . . . , 318O entered by the advertiser. In one embodiment, display module 502 may also display list of Web pages 404. In one embodiment, display module 502 may display first user interface element 302, second user interface element 316, and third user interface element 402.

Input module 504 is configured to receive a user selection of a Web page category from the plurality of Web page categories, where the selected Web page category includes a plurality of Web pages. Input module 504 is also configured to receive one or more key words. For example, input module 504 can receive user selection 310 of web page category, where the web page categories are displayed using display module 502. In one embodiment, display module 502 may be configured to display the advertiser selection of a Web page category, as shown by exemplary selection box 310. Display module 502 may be also configured to display the received key word(s) 318A, . . . , 318O.

In one embodiment, input module 504 is further configured to receive a user selection of one or more of the Web pages in the list of Web pages as a target for the placement of a display advertisement. For example, input module 504 may receive a user selection, such as denoted by selection box 408, of Web page 1 406A as the target for the placement of the display ad. In one embodiment, input module 504 is further configured to receive a user selection of the display advertisement for placement on each of the selected Web page(s).

Index search module 506 is configured to search an index that indexes a content of the plurality of Web pages included in the selected Web page category for the one or more key words to create a list of Web pages selected from among the plurality of Web pages. For example, index search module 506 is configured to search index 508 for keyword(s). Index module 506 may be an example implementation of index 118 of FIG. 1.

However, the invention is not limited to such embodiments, and other means for assisting a user with selecting web page(s) on which to place display advertisement(s) may be used.

### E. Example Computer System Implementations

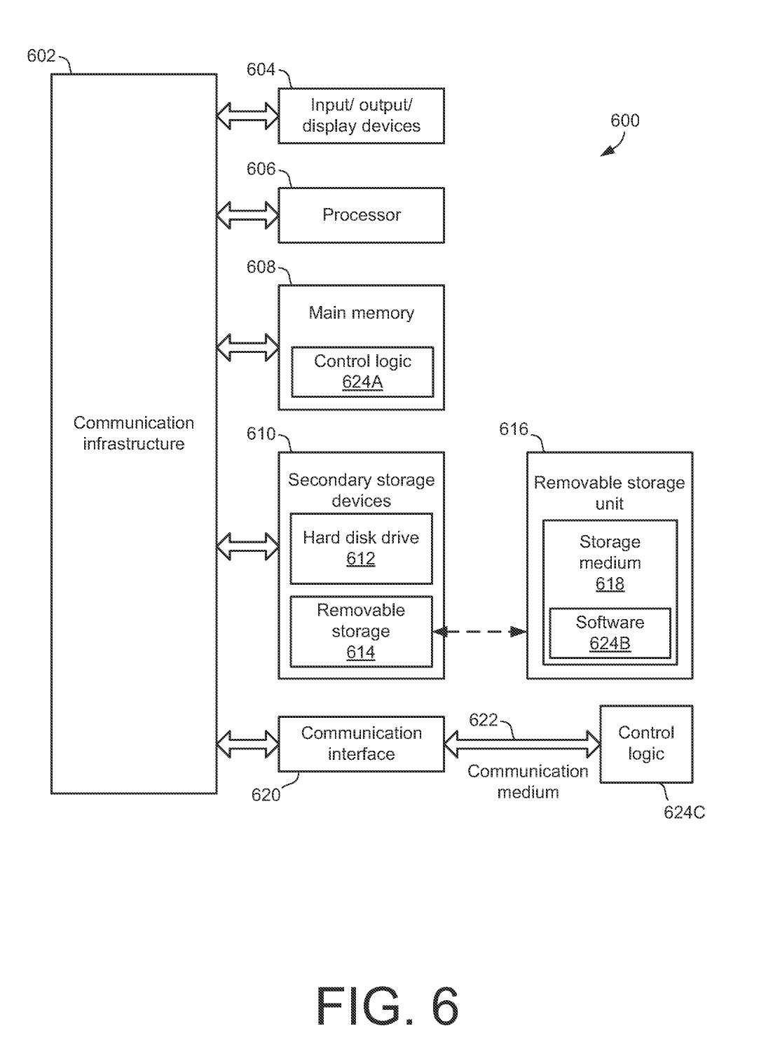

The embodiments described herein, including systems, methods/processes, and/or apparatuses, may be implemented using well known servers/computers, such as computer 600 shown in FIG. 6. For example, publisher Web servers 106 and Web page selection system 114 of FIG. 1, the method described in flowchart 200 depicted in FIG. 2, and Web page selection assistant 500 of FIG. 5 can be implemented using one or more computers 600.

Computer 600 can be any commercially available and well known computer capable of performing the functions described herein, such as computers available from International Business Machines, Apple, Sun, HP, Dell, Cray, etc. Computer 800 may be any type of computer, including a desktop computer, a server, etc.

Computer 600 includes input/output/display devices 604, such as monitors, keyboards, pointing devices, etc.

Computer 600 includes one or more processors (also called central processing units, or CPUs), such as a processor 606. Processor 606 is connected to a communication infrastructure 602, such as a communication bus. In some embodiments, processor 606 can simultaneously operate multiple computing threads.

Computer 600 also includes a primary or main memory 608, such as random access memory (RAM). Main memory 608 has stored therein control logic 624A (computer software), and data.

Computer 600 also includes one or more secondary storage devices 610. Secondary storage devices 610 include, for example, a hard disk drive 612 and/or a removable storage device or drive 614, as well as other types of storage devices, such as memory cards and memory sticks. For instance, computer 600 may include an industry standard interface, such a universal serial bus (USB) interface for interfacing with devices such as a memory stick. Removable storage drive 614 represents a floppy disk drive, a magnetic tape drive, a compact disk drive, an optical storage device, tape backup, etc.

Removable storage drive 614 interacts with a removable storage unit 616. Removable storage unit 616 includes a computer useable or readable storage medium 618 having stored therein computer software 624B (control logic) and/or data. Removable storage unit 616 represents a floppy disk, magnetic tape, compact disk, DVD, optical storage disk, or any other computer data storage device. Removable storage drive 614 reads from and/or writes to removable storage unit 616 in a well known manner.

Computer 600 further includes a communication or network interface 620. Communication interface 620 enables computer 600 to communicate with remote systems and devices. For example, communication interface 620 allows computer 600 to communicate over communication networks or mediums 622, such as LANs, WANs, the Internet, etc. Network interface 620 may interface with remote sites or networks via wired or wireless connections.

Control logic 624C may be transmitted to and from computer 600 via the communication medium 622. More particularly, computer 600 may receive and transmit carrier waves (electromagnetic signals) modulated with control logic 624C via communication medium 622.

Any apparatus or manufacture comprising a computer useable or readable medium having control logic (software) stored therein is referred to herein as a computer program product or program storage device. This includes, but is not limited to, computer 600, main memory 608, secondary storage devices 610, and removable storage unit 616. Such computer program products, having control logic stored therein that, when executed by one or more data processing devices, cause such data processing devices to operate as described herein, represent embodiments of the invention.

The invention can work with software, hardware, and/or operating system implementations other than those described herein. Any software, hardware, and operating system implementations suitable for performing the functions described herein can be used.

### F. Conclusion

While various embodiments of the present invention have been described above, it should be understood that they have been presented by way of example only, and not limitation. It will be apparent to persons skilled in the relevant art(s) that various changes in form and details may be made to the embodiments described above without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for assisting a user in selecting a Web page on which to place a display advertisement, comprising:
providing a first user interface element, using one or more processors, that allows a user to selectively obtain statistical information relating to each of a plurality of Web page categories and to select one or more of the Web page categories based on the statistical information;
providing a second user interface element that allows the user to submit one or more key words; and
providing a third user interface element that displays a list of Web pages obtained from the selected one or more Web page categories by performing a search based on the key word(s), that allows the user to selectively obtain statistical information relating to each Web page in the list of Web pages, and that allows the user to select one or more of the Web pages in the list of Web pages as a target for the placement of a display advertisement.

2. The method of claim 1, wherein performing the search based on the key word(s) comprises searching an index that indexes content of each Web page included in each of the selected one or more Web page categories for the key word(s).

3. The method of claim 1, wherein the statistical information relating to each of the plurality of Web page categories comprises, for each Web page category, demographic information associated with users that access Web pages in the Web page category.

4. The method of claim 1, wherein the statistical information relating to each of the plurality of Web page categories comprises, for each Web page category, page impression information for all the Web pages in the Web page category.

5. The method of claim 1, wherein the statistical information relating to each of the plurality of Web page categories comprises, for each Web page category, geographical distribution information associated with users that access Web pages in the Web page category.

6. The method of claim 1, wherein the statistical information relating to each Web page in the list of Web pages comprises demographic information associated with users that access each Web page in the list of Web pages.

7. The method of claim 1, wherein the statistical information relating to each Web page in the list of Web pages comprises page impression information for each Web page in the list of Web pages.

8. The method of claim 1, wherein the statistical information relating to each Web page in the list of Web pages comprises geographical distribution information associated with users that access each Web page in the list of Web pages.

9. The method of claim 1, further comprising:
accessing one or more Web logs to generate the statistical information relating to each of the plurality of Web page categories and
accessing the one or more Web logs to generate the statistical information relating to each Web page in the list of Web pages.

10. The method of claim 1, further comprising:
receiving selection of the display advertisement for placement on each of the selected Web page(s).

11. The method of claim 1,
wherein the plurality of the Web page categories are arranged using a hierarchical taxonomy; and
wherein the provided first user interface element allows the user to selectively obtain statistical information relating to each of the plurality of Web page categories in the hierarchical taxonomy and select the one or more of the Web page categories from any level in the hierarchical taxonomy.

12. A system for allowing users to select a Web page on which to place a display ad comprising:
a display module configured to display first statistical information relating to each of one or more of a plurality of Web page categories;
an input module configured to receive a user selection of a Web page category from the plurality of Web page categories and to receive one or more key words, the selected Web page category including a plurality of Web pages;
an index search module configured to search an index that indexes a content of the plurality of Web pages included in the selected Web page category for the one or more key words to create a list of Web pages selected from among the plurality of Web pages; and
the display module being further configured to display second statistical information relating to each Web page in the list of Web pages.

13. The system of claim 11, wherein the input module is further configured to receive a user selection of one or more of the Web pages in the list of Web pages as a target for the placement of a display advertisement.

14. The system of claim 12, wherein the input module is further configured to receive a user selection of the display advertisement for placement on each of the selected Web page(s).

15. The system of claim 11, wherein the first statistical information comprises one or more of:
demographic information associated with users that access Web pages in each Web page category;
geographical distribution information associated with users that access Web pages in each Web page category; or
page impression information for all the Web pages in each Web page category.

16. The system of claim 11, wherein the second statistical information comprises one or more of:
demographic information associated with users that access each Web page in the list of Web pages; or
page impression information for each Web page in the list of Web pages.

17. The system of claim 11,
wherein the plurality of the Web page categories are arranged using a hierarchical taxonomy; and
wherein the input module is configured to receive the user selection of the Web page category from any level in the hierarchical taxonomy.

18. A computer program product comprising a computer-readable medium having computer program logic recorded thereon for enabling a processor to assist a user in selecting a Web page on which to place a display advertisement, the computer program logic comprising:
first means for enabling the processor to provide a first user interface element that allows a user to selectively obtain statistical information relating to each of a plurality of Web page categories and to select one or more of the Web page categories based on the statistical information; and
second means for enabling the processor to provide a second user interface element that allows the user to select a filter that is to be applied to the selected one or more of the Web page categories to select one or more Web pages as a target for placement of a display advertisement.

19. The computer program product of claim 17, wherein the second user interface element allows the user to select:
a filter that selects the one or more Web pages based on demographic information;
a filter that selects the one or more Web pages based on page impression information; or
a filter that selects the one or more Web pages based on geographical distribution information.

20. The computer program product of claim 17, wherein the second user interface element allows the user to select:
a filter that searches an index that indexes content of Web pages in the selected one or more Web page categories for one or more keywords.
